(19) United States
(12) Patent Application Publication
(10) Pub. No.: US 2014/0285753 A1
(43) Pub. Date: Sep. 25, 2014

(54) DISPLAY DEVICE

(71) Applicant: Kabushiki Kaisha Toshiba, Minato-ku (JP)

(72) Inventors: Hitoshi NAGATO, Tokyo (JP); Takashi MIYAZAKI, Kanagawa-ken (JP); Rei HASEGAWA, Kanagawa-ken (JP); Koji SUZUKI, Kanagawa-ken (JP); Masaki ATSUTA, Kanagawa-ken (JP)

(73) Assignee: Kabushiki Kaisha Toshiba, Minato-ku (JP)

(21) Appl. No.: 14/171,922

(22) Filed: Feb. 4, 2014

(30) Foreign Application Priority Data
Mar. 19, 2013 (JP) 2013-056717

(51) Int. Cl. G02F 1/1335

(52) U.S. Cl. CPC G02F 1/133514
USPC 349/96

(57) ABSTRACT

According to one embodiment, a display device includes a first polarizing layer configured to transmit light polarized in a first direction, a second polarizing layer configured to transmit light polarized in a second direction, a display layer provided between the first polarizing layer and the second polarizing layer, an interference filter provided between the first polarizing layer and the display layer, and a refracting layer. The refracting layer includes a first layer and a second layer contacting the first layer. The second polarizing layer is disposed between the refracting layer and the display layer. The second layer is provided between the first layer and the second polarizing layer. The first layer includes a protrusion extending along the first direction and protruding toward the second polarizing layer.

### CROSS-REFERENCE TO RELATED APPLICATIONS

This application is based upon and claims the benefit of priority from Japanese Patent Application No. 2013-056717, filed on Mar. 19, 2013; the entire contents of which are incorporated herein by reference.

### FIELD

Embodiments described herein relate generally to a display device.

### BACKGROUND

The demand for display devices such as liquid crystal displays, plasma displays, organic EL displays, etc., is increasing even more due to the start of digital terrestrial broadcasting and the popularity of the internet and mobile telephones. In such a display device, a color filter is disposed; and a color display is provided by red, green, and blue light that pass through the color filter. Generally, a light-absorbing (absorption) color filter that uses a pigment or a dye is used. The absorption color filter transmits light in a designated wavelength region and absorbs light in the other wavelength regions. For example, when white light is incident on a blue color filter, blue light passes through the color filter; and green and red light are absorbed by the color filter. Green and red color filters also are similar. Thus, a loss of the light occurs because a portion of the incident light is absorbed by the color filters.

Therefore, a display device that uses an interference color filter instead of the absorption color filter has been proposed. The interference color filter reflects the light in the wavelength regions other than the wavelength region that is transmitted.

### BRIEF DESCRIPTION OF THE DRAWINGS

FIG. 1 is a plan view showing the display device according to the first embodiment;

FIG. 2 is a cross-sectional view showing the display device according to the first embodiment;

FIG. 3A is a schematic view describing a P-wave; and FIG. 3B is a schematic view describing an S-wave;

FIG. 4 describes color changes of the P-wave and the S-wave;

FIG. 5 is a cross-sectional view showing the display device according to the first embodiment;

FIG. 6A shows the refractive indexes for silicon oxide and silicon nitride; and FIG. 6B shows the extinction coefficients for silicon oxide and silicon nitride;

FIG. 7A shows an example of transmission spectra of the interference filter; and FIG. 7B shows an example of reflectance spectra;

FIG. 8 shows an example of transmission spectra of the absorption filter;

FIG. 9A is a cross-sectional view showing a display device according to a first modification of the first embodiment; and FIG. 9B is a cross-sectional view showing a display device according to a second modification of the first embodiment; and

FIG. 10 shows a method for manufacturing the display device according to the first embodiment.

### DETAILED DESCRIPTION

According to one embodiment, a display device includes a first polarizing layer configured to transmit light polarized in a first direction, a second polarizing layer configured to transmit light polarized in a second direction, a display layer provided between the first polarizing layer and the second polarizing layer, an interference filter provided between the first polarizing layer and the display layer, and a refracting layer. The refracting layer includes a first layer and a second layer contacting the first layer. The second polarizing layer is disposed between the refracting layer and the display layer. The second layer is provided between the first layer and the second polarizing layer. The first layer includes a protrusion extending along the first direction and protruding toward the second polarizing layer.

Embodiments according to the invention and embodiments according to comparative examples will be described hereinafter with reference to the accompanying drawings.

The drawings are schematic or conceptual; and the relationships between the thicknesses and widths of portions, the proportions of sizes between portions, etc., are not necessarily the same as the actual values thereof.

Further, the dimensions and/or the proportions may be illustrated differently between the drawings, even for identical portions. In the drawings and the specification of the application, components similar to those described in regard to a drawing thereinabove are marked with like reference numerals, and a detailed description is omitted as appropriate.

### First Embodiment

A display device according to a first embodiment will now be described. A liquid crystal display is described as the display device.

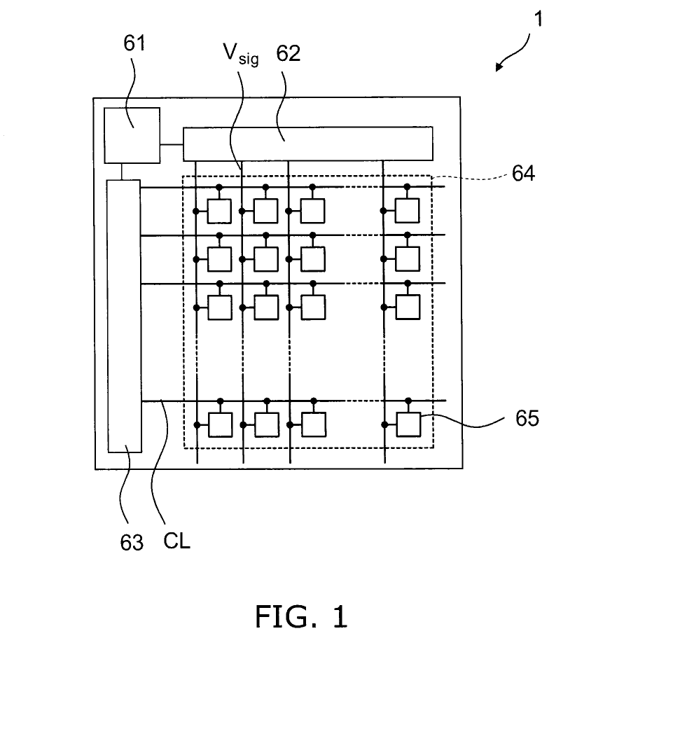

FIG. 1 is a plan view showing the display device according to the first embodiment.

The display device 1 includes a display region 64 in which multiple pixels 65 are provided in a matrix configuration; and the display device 1 includes a signal line drive circuit 62, a control line drive circuit 63, and a controller 61 that are provided around the display region 64.

The controller 61 is connected to the signal line drive circuit 62 and the control line drive circuit 63 and performs timing control of the operations of the signal line drive circuit 62 and the control line drive circuit 63. The pixels 65 that are arranged in a column direction are connected to the signal line drive circuit 62 by a signal line Vsig. Multiple columns of the pixels 65 are formed; and the signal line Vsig is multiply provided. The pixels 65 that are arranged in a row direction are connected to the control line drive circuit 63 by a control line CL. Multiple rows of the pixels 65 are formed; and the control line CL is multiply provided. The signal line drive circuit 62 supplies signal voltages to the pixels 65 via the signal lines Vsig. The control line drive circuit 63 supplies scanning line drive signals to the pixels 65 via the control lines CL.

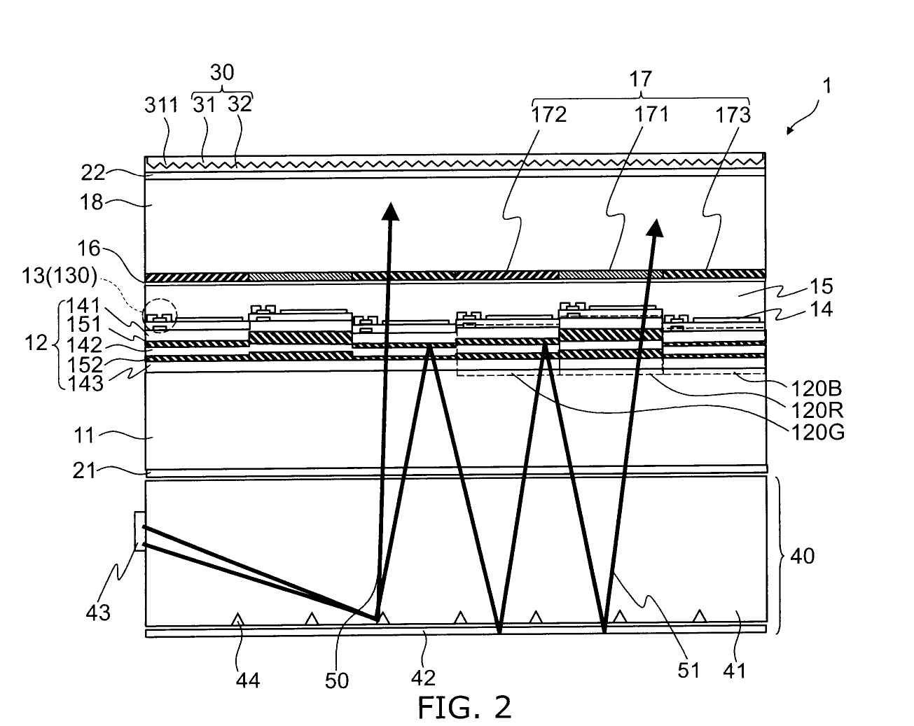

FIG. 2 is a cross-sectional view showing the display device according to the first embodiment.

The display device 1 includes a first polarizing layer 21 and a second polarizing layer 22 that oppose each other, a display layer 15 that is provided between the first polarizing layer 21 and the second polarizing layer 22, an interference filter 12 that is provided between the first polarizing layer 21 and the display layer 15, and a refracting layer 30 that opposes the first polarizing layer 21 with the second polarizing layer 22 interposed. The second polarizing layer 22 is disposed between the refracting layer 30 and the display layer 15.

The first polarizing layer 21 and the second polarizing layer 22 are layers that transmit light that is polarized in designated directions. The first polarizing layer 21 transmits light that is polarized in a first direction. The second polarizing layer 22 transmits light that is polarized in a second direction. The first polarizing layer 21 and the second polarizing layer 22 are provided such that, for example, the first direction and the second direction are substantially orthogonal to each other. Herein, the polarization directions of the first polarizing layer 21 and the second polarizing layer 22 may not be orthogonal to each other. For example, the angle between the polarization directions may be not less than 80 degrees and not more than 100 degrees.

The display layer 15 is, for example, a liquid crystal layer including liquid crystal molecules. The alignment of the liquid crystal molecules changes between a state in which an electric field is applied and a state in which the electric field is not applied; and the direction of the linearly polarized light passing through the display layer 15 changes. Accordingly, for example, the light that has passed through the display layer 15 cannot pass through the second polarizing layer 22 in the state in which the electric field is not applied; but the light that has passed through the display layer 15 can pass through the second polarizing layer 22 in the state in which the electric field is applied.

The display layer 15 is formed of, for example, a material having a changeable transmittance for light.

The interference filter 12 is a filter that transmits light in a designated wavelength region and reflects light in the other wavelength regions. The interference filter 12 is, for example, a Fabry-Perot-type interference filter. The interference filter 12 is, for example, a stack of multiple dielectric films having different refractive indexes. The interference filter 12 is formed by, for example, alternately stacking a layer of a high refractive index material and a layer of a low refractive index material. Typical dielectric materials having high refractive indexes include TiO₂, Ta₂O₃, ZnO₂, ZnS, ZrO₂, CeO₂, Sb₂S₃, etc. For example, low refractive index dielectric materials include SiO₂, MgF₂, Na₃AlF₆, etc. A detailed configuration of the interference filter 12 is described below.

The refracting layer 30 includes a first layer 31 and a second layer 32. The first layer 31 opposes the second polarizing layer 22 with the second layer 32 interposed. The first layer 31 includes a protrusion 311 extending along the first direction and protruding toward the second polarizing layer 22. The second layer 32 is provided between the first layer 31 and the second polarizing layer 22 to contact the first layer 31. The protrusion 311 extends along the first direction.

For example, a line that connects multiple points of the protrusion 311 in a cross section perpendicular to the first direction for which the distance from the second polarizing layer 22 is greatest is substantially parallel to the first direction. The protrusion 311 protrudes toward the second polarizing layer. Herein, “substantially parallel” may be completely parallel; or, for example, the angle between the first direction and the line may be not less than 0 degrees and not more than 10 degrees. It is favorable for the angle between the first direction and the line to be not less than 0 degrees and not more than 5 degrees. The first layer 31 may include multiple protrusions 311. The protrusions 311 extend in the first direction parallel to one major surface of the second polarizing layer 22. The multiple protrusions 311 are arranged, for example, in a direction intersecting the first direction. In the case where the protrusion 311 is multiply provided, a portion of the second layer 32 is provided between the multiple protrusions 311.

The protrusion 311 has a first tilted surface and a second tilted surface that are tilted with respect to a direction perpendicular to major surfaces of the first polarizing layer 21 and the second polarizing layer 22. The direction that is perpendicular to the major surfaces of the first polarizing layer 21 and the second polarizing layer 22 is the same as the direction in which the first polarizing layer 21, the display layer 15, and the second polarizing layer 22 are stacked. The first tilted surface and the second tilted surface may be planar surfaces or curved surfaces. For example, the first tilted surface and the second tilted surface extend in the first direction.

For example, a resin, glass, etc., may be used as the material of the first layer 31. For example, air may be used as the material of the second layer 32. A resin, glass, or the like that is different from that of the first layer 31 may be used as the material of the second layer 32. In the case where the second layer 32 is the air layer, the first layer 31 may be bonded to the second polarizing layer by a bonding layer provided along the outer circumference of the first layer 31. It is favorable for the difference between the refractive index of the first layer 31 and the refractive index of the second layer 32 to be 0.3 or more. It is favorable for the refractive index of the second layer 32 to be lower than the refractive index of the first layer 31.

The display device 1 may further include a backlight 40, a support substrate 11, a display circuit 130, a pixel electrode 14, an opposing electrode 16, an absorption filter 17, and a counter substrate 18.

The interference filter 12 is provided on the support substrate 11. The display circuit 130 is provided on the interference filter 12 and includes a pixel-driving transistor 13. The pixel electrode 14 is provided on the interference filter 12. The display layer 15 is provided on the display circuit 130 and the pixel electrode 14. The opposing electrode 16 is provided on the display layer 15. The absorption filter 17 is provided on the opposing electrode 16. The counter substrate 18 is provided on the absorption filter 17. The first polarizing layer 21 and the second polarizing layer 22 are provided on the surfaces of the support substrate 11 and the counter substrate 18 on sides that do not oppose the display layer 15.

The support substrate 11 and the counter substrate 18 are formed of, for example, a material that is light-transmissive such as glass, a transparent resin, etc.

The pixel-driving transistor 13 controls a voltage applied between the pixel electrode 14 and the opposing electrode 16. For example, a bottom gate-type or top-gate type thin film transistor is used as the pixel-driving transistor 13. For example, one pixel-driving transistor 13 may be disposed for every one pixel.

The display circuit 130 is a circuit that receives the signal voltage and the scanning line drive signal and controls the voltage applied to the display layer 15 for each pixel.

The pixel electrode 14 and the opposing electrode 16 apply the voltage to the display layer 15. The pixel electrode 14 and the opposing electrode 16 are formed of, for example, a conductive material that is light-transmissive such as indium tin oxide, etc. When the voltage is applied between the pixel electrode 14 and the opposing electrode 16, the alignment of the liquid crystal of the display layer 15 provided between the pixel electrode 14 and the opposing electrode 16 changes; and the light that travels through the display layer 15 does or does not pass through the second polarizing layer 22. Thus, the display device 1 can perform the image display by the second polarizing layer 22 transmitting or not transmitting the light.

The interference filter 12 includes a red interference filter 120R, a green interference filter 120G, and a blue interference filter 120B. The red interference filter 120R transmits the light in the red wavelength region and reflects the light in the other wavelength regions including green and blue. The green interference filter 120G transmits the light in the green wavelength region and reflects the light in the other wavelength regions including red and blue. The blue interference filter 120B transmits the light in the blue wavelength region and reflects the light in the other wavelength regions including red and green. Herein, the light in the wavelength region passing through the interference filter 12 refers to the light in the wavelength region having a transmittance higher than that of the other wavelength regions; and the light in the wavelength region reflected by the interference filter 12 refers to the light in the wavelength region having a reflectance that is higher than (having a transmittance that is lower than) that of the other wavelength regions. For example, the wavelength region corresponding to the width at half maximum of the transmission spectrum of the interference filter 12 may be taken as the wavelength region of the light passing through the interference filter.

The absorption filter 17 is a filter that transmits the light in a designated wavelength region, absorbs the light in the other wavelength regions, and is formed of, for example, a pigment, a dye, etc. The absorption filter 17 includes, for example, a red absorption filter 171, a green absorption filter 172, and a blue absorption filter 173. One selected from the absorption filters 171, 172, and 173 of the colors is provided in one pixel.

The absorption filter 17 opposes the interference filter 12 with the display layer 15 interposed. The red absorption filter 171 opposes the red interference filter; the green absorption filter 172 opposes the green interference filter; and the blue absorption filter 173 opposes the blue interference filter. The backlight 40 includes a reflective unit 42 opposing the support substrate 11, a light guide unit 41 provided between the support substrate 11 and the reflective unit 42, and a light source 43 provided at the side surface of the light guide unit 41. The first polarizing layer 21, the interference filter 12, the display layer 15, and the second polarizing layer 22 are disposed between the backlight 40 and the refracting layer 30. The light guide unit 41 has a recess 44 on the side (the bottom surface) of the light guide unit 41 opposing the reflective unit 42.

The light guide unit 41 is formed of a material that is light-transmissive such as an acrylic resin, etc. For example, an LED, etc., is used as the light source 43. The reflective unit 42 is formed of a material having a high light reflectivity and is formed of, for example, a metal such as aluminum, etc. The recess 44 has at least one tilted surface that is tilted with respect to the surface of the light guide unit 41 opposing the reflective unit 42. The recess 44 may have, for example, a pyramid configuration or a hill configuration having a triangular cross section.

For example, an electric field is applied to the display layer 15 by the voltage that is controlled by the pixel-driving transistor 13 being applied between the pixel electrode 14 and the opposing electrode 16. The image display is performed by the light from the backlight 40 being switched between ON and OFF.

The light that is produced by the light source 43 enters the light guide unit 41 and travels through the light guide unit 41 while undergoing total internal reflections. At this time, when the light reaches the recess 44, the light is reflected in the direction of the upper surface where the first polarizing layer 21 is positioned because the conditions for total internal reflection are no longer satisfied due to the recess 44. The light that is reflected is emitted from the light guide unit 41, passes through the support substrate 11, and is incident on the interference filter 12. The light that is incident on the interference filter 12 and is in the transmission region of the interference filter passes through the interference filter 12 as illustrated by a light ray 50, passes through the display layer 15 and the absorption filter 17, and is emitted outside the display device 1.

On the other hand, substantially all of the light that is incident on the interference filter 12 and is not in the transmission region of the interference filter 12 is reflected and returned to the backlight 40 side. For example, although a light ray 51 is an example of red light, the light propagates through the light guide unit 41 while repeating total internal reflections at the bottom surface of the light guide unit 41 and at the green or blue interference filters. Then, when the light reaches the red interference filter 120R, the light passes through the red interference filter 120R, passes through the display layer 15 and the absorption filter 17, and is emitted outside the display device 1.

Thus, the loss of light in the display device 1 is low because substantially all of the light from the backlight 40 can pass through one selected from the interference filters 12 of the colors because the absorption of the light by the interference filter 12 is lower than that of the absorption filter 17.

However, the light that passes through the interference filter 12 reaches the viewer (the user) via the second polarizing layer 22. In particular, the Fabry-Perot-type interference filter 12 uses the interference of light based on an optical thin film group configuration. The light that is obliquely incident on the interference filter 12 has a long optical path length when passing through the interference filter 12. Therefore, the light that is obliquely incident on the interference filter 12 shifts to the short wavelength side, i.e., the blue side, when passing through the interference filter 12. Restated, the color of the image when the display device 1 is viewed from the oblique direction undesirably is greatly different from the color of the image viewed from the frontward direction. The frontward direction is a direction perpendicular to the major surfaces of the first polarizing layer 21, the second polarizing layer 22, and the interference filter 12. For example, when the light that passes through the red interference filter 120R is viewed, the color of the viewed light changes from red to orange, yellow, and green as the angle of the viewing direction (the viewing angle) with respect to the frontward direction of the display device 1 increases.

To improve this quality, the absorption filter 17 can be provided to oppose the backlight 40 with the interference filter 12 interposed. The light that is obliquely incident on the interference filter 12 and has its wavelength shifted drastically to blue side is absorbed by the absorption filter 17. Accordingly, the light that has its wavelength shifted drastically is not viewed. For example, the light that passes through the red interference filter 120R and is shifted toward green is absorbed by the red absorption filter 171. Thus, the shift amount of the wavelength is suppressed by the absorption filter 17 to be within the range of wavelengths that pass through the red absorption filter 17.

Here, the inventor discovered the following as a result of diligent research. Namely, the intensity change as the viewing angle is increased is different between the colors (e.g., red, green, blue, etc.) of the viewed light. If the intensities of the colors dependent on the viewing angle were to change uniformly, white light that is viewed from the front would be viewed as gradually becoming dark as the viewing angle is increased.

However, it was found that the light is viewed to have colors other than white as the viewing direction becomes oblique when the intensity change is different according to color. Further, it was also found that this phenomenon differs according to the relationship between the viewing direction and the transmission axis (the first direction) of the first polarizing layer. These phenomena are described below in detail.

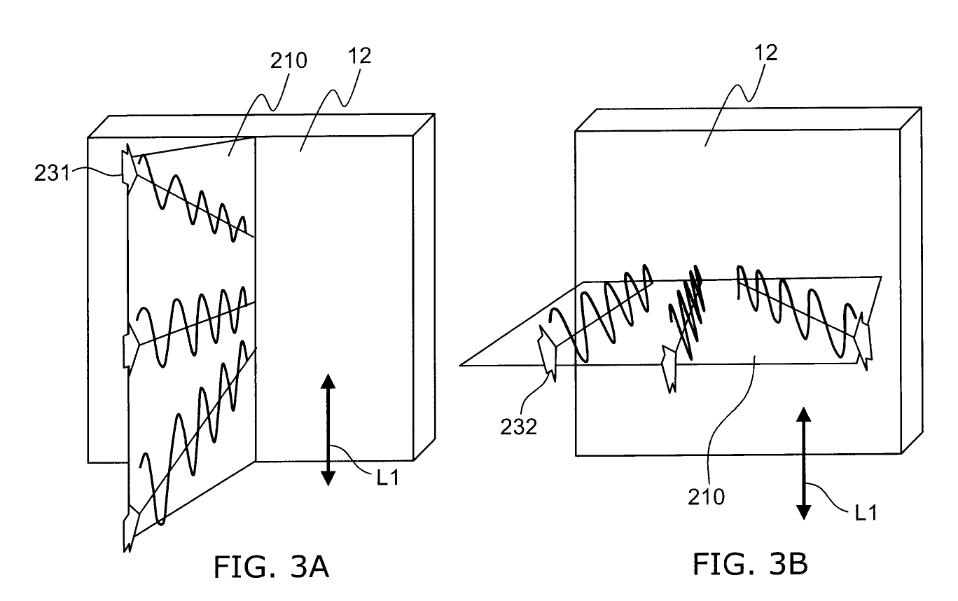

FIG. 3A is a schematic view describing a P-wave; and FIG. 3B is a schematic view describing an S-wave.

A vibration direction L1 is the vibration direction of the electric field. The direction of the electric field for the light passing through the first polarizing layer 21 is aligned by the first polarizing layer 21 to become linearly polarized light. The electric field of a P-wave 231 of the light vibrates parallel to an incident surface 210. The electric field of an S-wave 232 of the light vibrates perpendicularly to the incident surface 210. The P-wave and the S-wave have different reflection characteristics and transmission characteristics for the interference filter 12.

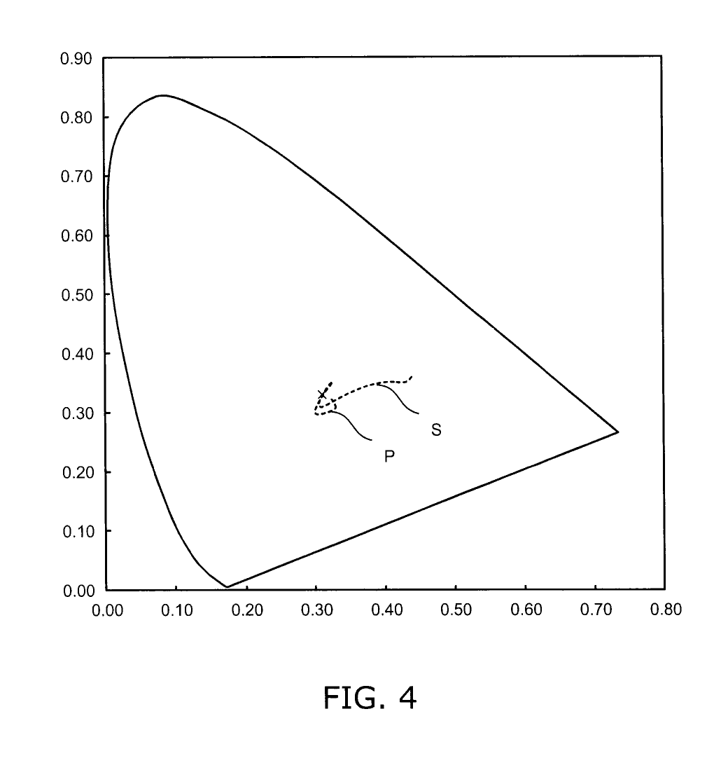

FIG. 4 describes color changes of the P-wave and the S-wave.

The relationship between the viewing angle and the color change is shown as chromaticity coordinates for the display device 1 that displays white and has the configuration shown in FIG. 1. Here, the viewing angle refers to the angle between the viewing direction and the direction (the frontward direction) perpendicular to the major surface of the display layer 15. The color of the viewed light is shown for viewing angles of 20 degrees, 40 degrees, 60 degrees, and 80 degrees for the P-wave (P) and the S-wave (S). The color of the light at the target center is illustrated by the X mark. For both the P-wave and the S-wave, the target center overlaps the color when viewed from the frontward direction (an angle of 0 degrees).

For the P-wave, although the color of the light gradually moves away from the target center as the viewing angle is increased, the color change with respect to the change of the viewing direction is not very large. On the other hand, for the S-wave, the color of the light gradually moves away from the target center as the viewing angle is increased; and the color change with respect to the change of the viewing angle is extremely large. For the S-wave, the color moves in the red direction as the viewing angle increases. In other words, in the case where white light is incident on the interference filter 12, the S-wave that passes through the interference filter 12 appears to be red when viewed at a large viewing angle.

Here, the display device 1 includes the refracting layer 30. The color change when viewing from a direction oblique to the frontward direction can be suppressed by the refracting layer 30.

The refracting layer 30 can suppress the color change due to the S-wave for which the particularly large color change occurs easily.

The suppression of the color change by the refracting layer 30 will now be described.

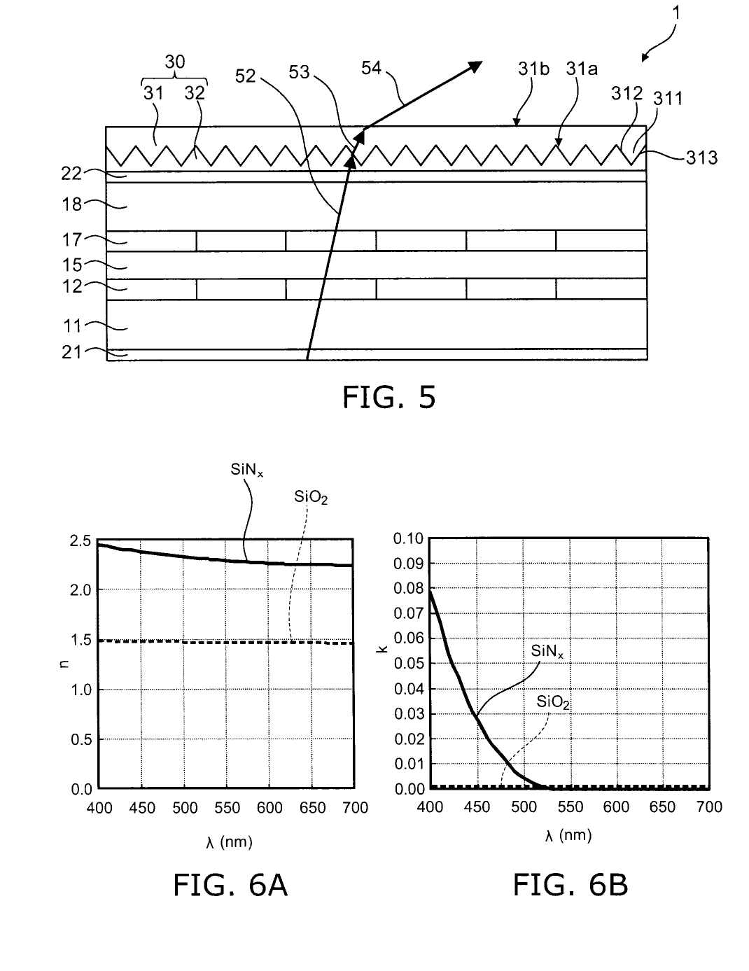

FIG. 5 is a cross-sectional view showing the display device according to the first embodiment.

FIG. 5 shows the same device as the display device 1 shown in FIG. 1, although the illustration of interference filter 12 is simplified, and the backlight 40 and the display circuit 130 are not shown.

In the embodiment, the protrusion 311 of the refracting layer 30 is a prism having an apex angle of 90 degrees. The protrusion 311 extends in the first direction parallel to the major surface of the first polarizing layer 21 and is multiply arranged in another direction parallel to the major surface. The protrusion 311 is provided on a first major surface 31a side of the first layer 31 opposing the second polarizing layer 22. A second major surface 31b of the first layer 31 which is the major surface on the side opposite to the first major surface 31a is a planar surface. The second major surface 31b may not be a planar surface; and, for example, an uneven structure may be provided. The protrusion 311 has a first tilted surface 312 and a second tilted surface 313. It is favorable for the angle between the first tilted surface 312 and the second tilted surface 313 to be not less than 80 degrees and not more than 100 degrees, more favorable to be not less than 85 degrees and not more than 95 degrees, and even more favorable to be 90 degrees.

Light 52 passes through the interference filter 12, passes through the display layer 15 and the counter substrate 18, and enters the protrusion 311 of the refracting layer 30 from the first tilted surface 312 or the second tilted surface 313. The light 52 enters the protrusion 311 by refraction due to the refractive index difference between the first layer 31 and the second layer 32. Light 53 that enters the first layer 31 is refracted at the second major surface 31b and is emitted outside the display device 1 as light 54.

Thus, the light 54 that is emitted from the refracting layer 30 obliquely with respect to the frontward direction has passed through the interference filter 12 in a direction close to the frontward direction. The light that passes through the interference filter 12 in the direction close to the frontward direction does not have a large color change. Accordingly, when viewing such a display device 1 obliquely, an image having a small color change with respect to the image viewed from the frontward direction can be obtained.

For example, the case is considered where the first layer 31 is a right-angle 90-degree prism array sheet formed of polycarbonate having a refractive index of 1.585, and the second layer 32 is an air layer. The light 54 that is emitted at 90 degrees with respect to the frontward direction from the first layer 31 has passed through the interference filter 12 at an angle of about 35.5 degrees with respect to the frontward direction. Accordingly, the light that passes through the interference filter 12 at a small angle not more than about 35.5 degrees with respect to the frontward direction is viewed. Accordingly, the color change of the image is small even when viewed obliquely.

The color change increases due to the transmitted wave of the S-wave. Because the direction in which the column of the protrusions 311 is arranged is one dimension, the color change due to the S-wave can be suppressed by aligning the direction of the column with the direction in which the large color change of the S-wave can be suppressed. In other words, the large color change due to the S-wave can be suppressed by setting the first direction of the first polarizing layer 21 to be substantially parallel to the direction in which the protrusions 311 extend.

According to the display device 1 according to the embodiment as described above, the color change that undesirably occurs when viewing from a direction oblique to the frontward direction can be improved drastically. Also, because the display device 1 uses the interference filter 12, the utilization efficiency of the light of the backlight is high.

In the display device 1, the interference filter 12 may be provided between the display layer 15 and the counter substrate 18; and the absorption filter 17 may be provided between the support substrate 11 and the display layer 15.

The absorption filter 17 may be provided between the second polarizing layer 22 and the refracting layer 30.

The absorption filter 17 may be provided to oppose the second polarizing layer 22 with the refracting layer 30 interposed.

A specific configuration of the interference filter 12 will now be described.

The wavelength region (the transmission region) of the light transmitted by the interference filter 12 is determined by the material of the dielectric multilayer film, the thickness of the dielectric multilayer film, and the number of stacks of the dielectric multilayer film. It is desirable to use an ideal interference filter 12 having low loss of the light such as that which transmits substantially 100% of the light in the transmission region and reflects substantially 100% of the light in the other wavelength regions (the reflection region) when white light is incident.

The interference filter 12 is formed of multiple stacked dielectric films. The interference filter 12 includes, for example, two common layers and a spacer layer provided between the common layers. In the embodiment as shown in FIG. 2, the interference filter 12 includes a first common layer 141, a second common layer 142, a third common layer 143, a first spacer layer 151, and a second spacer layer 152. The first spacer layer 151 is provided between the first common layer 141 and the second common layer 142. The second spacer layer 152 is provided between the second common layer 142 and the third common layer 143.

The first common layer 141, the second common layer 142, and the third common layer 143 each are provided as one continuous film at the red interference filter 120R, the green interference filter 120G, and the blue interference filter 120B. The thickness of the first spacer layer 151 is different between the red interference filter 120R, the green interference filter 120G, and the blue interference filter 120B. The thickness of the second spacer layer 152 is different between the red interference filter 120R, the green interference filter 120G, and the blue interference filter 120B. Accordingly, the thicknesses of the red interference filter 120R, the green interference filter 120G, and the blue interference filter 120B are mutually different. The first common layer 141, the second common layer 142, the third common layer 143, the first spacer layer 151, and the second spacer layer 152 are formed of, for example, a single layer of a dielectric multilayer film or a stacked body of dielectric multilayer films.

FIG. 6A shows the refractive indexes for silicon oxide and silicon nitride; and FIG. 6B shows the extinction coefficients for silicon oxide (SiO₂) and silicon nitride (SiNₓ).

In FIG. 6A, the horizontal axis is a wavelength λ (units: nm); and the vertical axis is a refractive index n. In FIG. 6B, the horizontal axis is a wavelength λ (units: nm); and the vertical axis is the extinction coefficient k. For example, a silicon nitride film adjusted such that the refractive index is 2.3 for the vicinity of a wavelength of 550 nm may be used as the silicon nitride film.

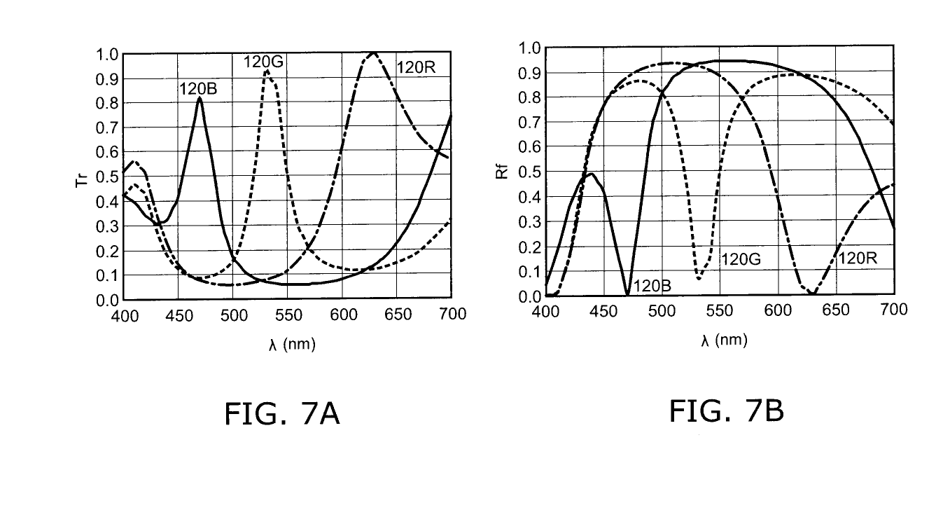

Examples of characteristics of the interference filter 12 formed of such a silicon oxide film and such a silicon nitride film are shown in FIG. 7A and FIG. 7B.

FIG. 7A shows transmission spectra of the interference filter; and FIG. 7B shows an example of reflectance spectra. In FIG. 7A, the horizontal axis is the wavelength λ, (units: nm) of the light; and the vertical axis is a transmittance Tr. In FIG. 7B, the horizontal axis is the wavelength λ (units: nm) of the light; and the vertical axis is a reflectance Rf.

In FIG. 7A and FIG. 7B, the film thicknesses of the first spacer layer 151 and the second spacer layer 152 for each filter are as follows. Namely, the film thickness of the red interference filter 120R is about 30 nm; the film thickness of the blue interference filter 120B is about 115 nm; and the film thickness of the green interference filter 120G is about 78 nm. Thus, the interference filter 12 is a filter that transmits the light in the designated wavelength region and reflects the light in the other wavelength regions.

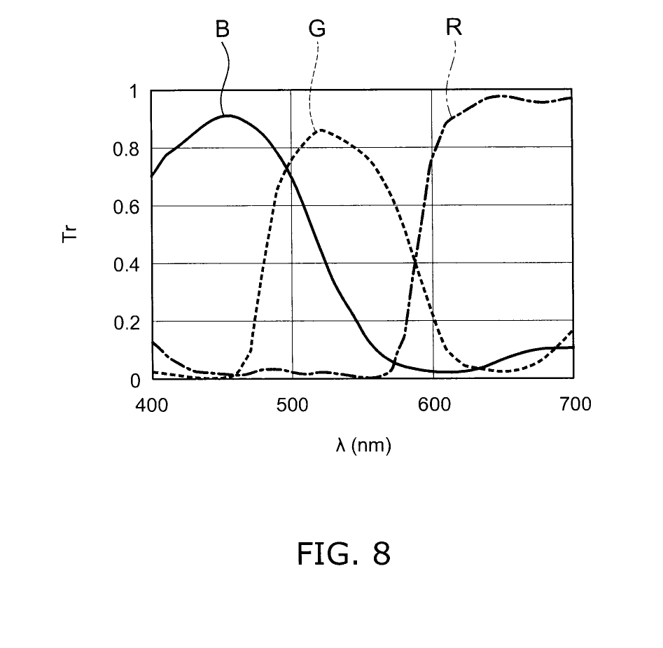

FIG. 8 shows an example of transmission spectra of the absorption filter 17.

In FIG. 8, the horizontal axis is the wavelength λ (units: nm) of the light; and the vertical axis is the transmittance Tr. Generally, the transmission region of the absorption filter 17 is wider than that of the interference filter 12. For example, light of a wavelength of about 410 nm passes through the red interference filter 120R shown in FIG. 7A but is absorbed by the red absorption filter 171. In other words, the component of the light passing through the interference filter 12 for which the color purity has degraded is absorbed by the absorption filter 17. Thus, light having a highly pure color can be obtained by combining the interference filter 12 and the absorption filter 17.

The NTSC ratio of the color gamut of the interference filter 12 is, for example, about 30%. The NTSC ratio of the color gamut of the absorption filter 17 is, for example, about 55%. The color purity can be higher for the case where these filters are used in combination than for the case where one selected from these filters is used.

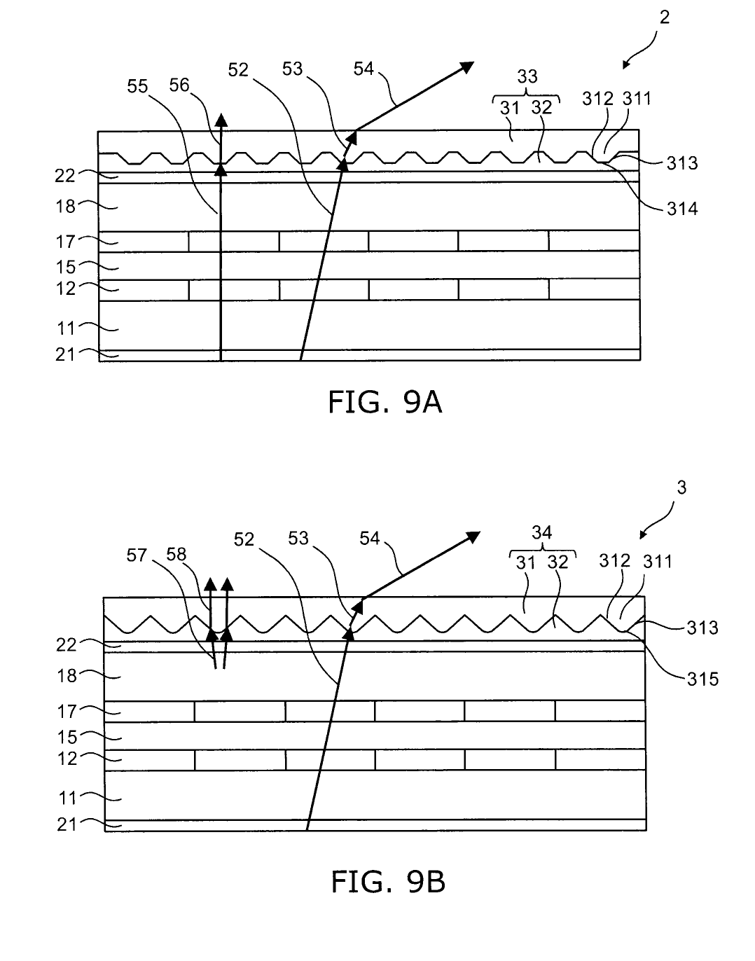

FIG. 9A is a cross-sectional view showing a display device according to a first modification of the first embodiment.

The configuration of a refracting layer 33 of the display device 2 according to the first modification is different from that of the display device 1. In other words, a planar surface 314 is formed between the first tilted surface 312 and the second tilted surface 313 of one protrusion 311 of the first layer 31. The planar surface 314 is parallel to the major surfaces of the first polarizing layer 21 and the second polarizing layer 22. The light 52 that passes through the second polarizing layer 22 and is incident on the first tilted surface 312 or the second tilted surface 313 is refracted at the first tilted surface 312 or the second tilted surface 313 and enters the first layer 31. The light 53 that enters the first layer 31 passes through the first layer 31 and is refracted at the surface of the first layer 31 on the side opposite to the surface opposing the display layer 15; and the light 54 is viewed by the viewer.

On the other hand, light 55 passes through the second polarizing layer 22, is perpendicularly incident on the planar surface 314, and enters the first layer 31 as-is without being refracted at the planar surface 314. Light 56 enters the first layer 31, passes through the first layer 31, and is emitted from the first layer 31 without being refracted at the surface of the first layer 31 on the side opposite to the surface opposing the display layer 15. Thus, the light that passes through the refracting layer 33 according to the first modification includes more light in the direction perpendicular to the major surface of the first polarizing layer 21 than does the light that passes through the refracting layer 30 according to FIG. 5. Accordingly, an image having high luminance can be obtained when the display device 2 is viewed from the front.

FIG. 9B is a cross-sectional view showing a display device according to a second modification of the first embodiment.

The configuration of a refracting layer 34 of the display device 3 according to the second modification is different from that of the display device 1. In other words, a curved surface 315 is formed between the first tilted surface 312 and the second tilted surface 313 of one protrusion 311 of the first layer 31.

A portion 57 of the light passing through the second polarizing layer 22 to be perpendicularly incident on the curved surface 315 is refracted at the curved surface 315 and enters the first layer 31. The light 57 travels through the first layer 31 in a direction perpendicular to the major surface of the first polarizing layer 21 and is emitted from the first layer 31 without being refracted at the surface of the first layer 31 opposite to the surface opposing the display layer 15. Thus, the light that passes through the refracting layer 34 according to the second modification includes more light in the direction perpendicular to the major surface of the first polarizing layer 21 than does the light that passes through the refracting layer 30 according to FIG. 5. Accordingly, an image having high luminance can be obtained when the display device 3 is viewed from the front.

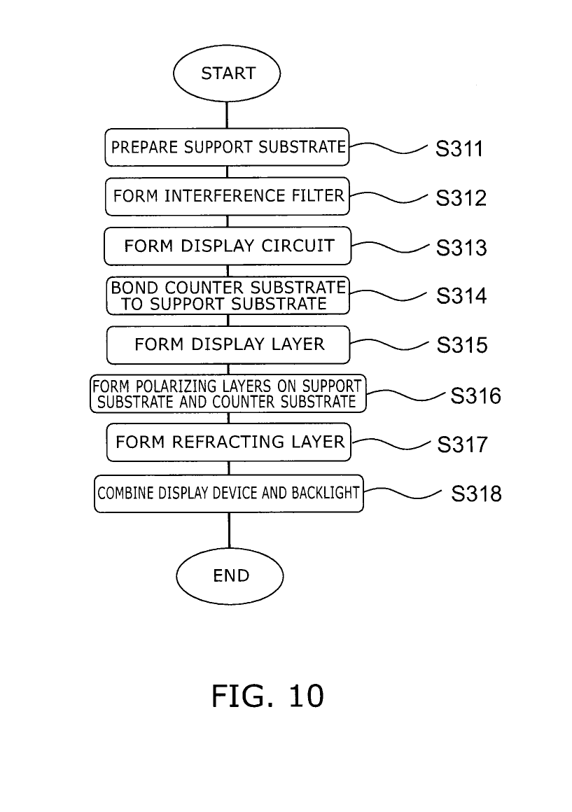

FIG. 10 shows a method for manufacturing the display device according to the first embodiment.

The method for manufacturing the display device includes step S311 of preparing the support substrate 11, step S312 of forming the interference filter 12 on the support substrate 11, step S313 of forming the display circuit 130 on the interference filter 12, step S314 of bonding the counter substrate 18 to the support substrate 11, step S315 of forming the display layer 15 between the support substrate 11 and the counter substrate 18, step S316 of forming the first polarizing layer 21 and the second polarizing layer 22 on the support substrate 11 and the counter substrate 18, and step S317 of forming the refracting layer 30 on the second polarizing layer 22.

The opposing electrode 16 may be provided at the counter substrate 18. The absorption filter 17 may be provided at the counter substrate 18.

In the embodiment, for example, the arrangement direction of the multiple pixels 65 may intersect the first direction. For example, the display layer 15 includes the multiple pixels 65 disposed in a plane perpendicular to the stacking direction from the first polarizing layer 21 toward the second polarizing layer 22. The angle between the first direction and the direction in which the multiple pixels 65 are arranged is not less than 10 degrees and not more than 80 degrees. Thereby, for example, moiré occurring due to the protrusions and the pixels is suppressed. For example, the angle may be not less than 10 degrees and not more than 35 degrees. The angle may be not less than 55 degrees and not more than 80 degrees.

An example of the method for manufacturing the interference filter 12 is described below.

First, the third common layer 143 is formed by CVD (chemical vapor deposition) on the support substrate 11. Further, the second spacer layer 152, the second common layer 142, the first spacer layer 151, and the first common layer 141 are formed by CVD on the third common layer 143. When forming these layers, continuous formation is possible by controlling the gas pressure, etc. In the display device, there are cases where a silicon oxide film or the like is formed as an undercoat layer to prevent the diffusion of impurities from the support substrate and increase the flatness of the support substrate. In the display device 1 according to the embodiment, the interference filter 12 may be formed without forming the undercoat layer.

Hereinabove, exemplary embodiments of the invention are described with reference to specific examples. However, the embodiments of the invention are not limited to these specific examples. The specific configurations of the components can be suitably selected from publicly known arts by those skilled in the art, and such configurations are encompassed within the scope of the invention as long as they can also implement the invention and achieve similar effects.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
a first polarizing layer configured to transmit light polarized in a first direction;
a second polarizing layer configured to transmit light polarized in a second direction;
a display layer provided between the first polarizing layer and the second polarizing layer;
an interference filter provided between the first polarizing layer and the display layer; and
a refracting layer including a first layer and a second layer contacting the first layer, the second polarizing layer being disposed between the refracting layer and the display layer, the second layer being provided between the first layer and the second polarizing layer, the first layer including a protrusion extending along the first direction and protruding toward the second polarizing layer.

2. The device according to claim 1, wherein a refractive index of the first layer is higher than a refractive index of the second layer.

3. The device according to claim 1, wherein a difference between a refractive index of the first layer and a refractive index of the second layer is not less than 0.3.

4. The device according to claim 1, wherein the protrusion has a first tilted surface and a second tilted surface, the first tilted surface and the second tilted surface being tilted with respect to a plane perpendicular to a direction of stacking of the first polarizing layer, the display layer, and the second polarizing layer.

5. The device according to claim 4, wherein the first tilted surface and the second tilted surface extend in the first direction.

6. The device according to claim 1, further comprising an absorption filter provided between the display layer and the second polarizing layer.

7. The device according to claim 1, wherein an angle between the first direction and the second direction is not less than 80 degrees and not more than 110 degrees.

8. The device according to claim 1, wherein the second direction intersects the first direction.

9. The device according to claim 1, further comprising a backlight configured to emit light,
the first polarizing layer, the interference filter, the display layer, and the second polarizing layer being disposed between the backlight and the refracting layer.

10. The device according to claim 1, wherein
the display layer includes a plurality of pixels disposed in a plane perpendicular to a stacking direction from the first polarizing layer toward the second polarizing layer, and
an angle between the first direction and an arrangement direction of the pixels is not less than 10 degrees and not more than 80 degrees.

11. The device according to claim 1, wherein
the display layer includes a plurality of pixels disposed in a plane perpendicular to a stacking direction from the first polarizing layer toward the second polarizing layer, and
an angle between the first direction and an arrangement direction of the pixels is not less than 10 degrees and not more than 35 degrees.

12. The device according to claim 1, wherein
the display layer includes a plurality of pixels disposed in a plane perpendicular to a stacking direction from the first polarizing layer toward the second polarizing layer, and
an angle between the first direction and an arrangement direction of the pixels is not less than 5.5 degrees and not more than 80 degrees.

13. The device according to claim 1, wherein the protrusion includes:
a first tilted surface tilted with respect to a plane perpendicular to a direction of stacking of the first polarizing layer, the display layer, and the second polarizing layer, the first tilted surface being a planar surface; and
a second tilted surface tilted with respect to the perpendicular plane, the second tilted surface being a planar surface.

14. The device according to claim 1, wherein
the first layer includes a resin, and
the second layer includes an air layer.

15. The device according to claim 1, wherein
the first layer includes glass, and
the second layer includes an air layer.

16. The device according to claim 1, wherein
the first layer includes a first resin, and
the second layer includes a second resin, a refractive index of the second resin being different from a refractive index of the first resin.

17. The device according to claim 1, wherein the protrusion is a prism, and an apical angle of the prism is not less than 80 degrees and not more than 110 degrees.

18. The device according to claim 1, wherein the protrusion is a prism, and an apical angle of the prism is not less than 85 degrees and not more than 95 degrees.

19. The device according to claim 1, wherein the protrusion is a prism, and an apical angle of the prism is 90 degrees.

20. The device according to claim 19, wherein the first layer includes a polycarbonate resin.
